(19) United States
(12) Patent Application Publication
(10) Pub. No.: US 2018/0013115 A1
(43) Pub. Date: Jan. 11, 2018

(54) BATTERY CASE FOR LIGHT-WEIGHT WATERCRAFT

(71) Applicant: Mark A. Schmidtke, Charlotte, NC (US)

(72) Inventor: Mark A. Schmidtke, Charlotte, NC (US)

(21) Appl. No.: 15/202,884

(22) Filed: Jul. 6, 2016

(51) Int. Cl. H01M 2/10; B63B 35/71

(52) U.S. Cl. CPC H01M 2/1083; B63B 35/71; H01M 2220/20; B63B 2035/715

(57) ABSTRACT

A method for housing a battery used on a light-weight, motor powered watercraft includes the step of: providing a battery case having: a pod sized to house a marine battery, the pod having a cavity for the marine battery and an open top; a lid for at least water-resistant closure of the open top of the pod, the lid having a cavity and an open bottom, the lid is releasably attachable to the pod; and a floor releasably attached to the lid adjacent the open bottom, the floor adapted to hold controls for the light-weight, motor powered watercraft.

### FIELD OF THE INVENTION

The invention is directed to a battery case for a light-weight, motor powered watercraft, such as a kayak or a canoe.

### BACKGROUND OF THE INVENTION

Light-weight watercraft include, for example, kayaks and canoes. Kayaks and canoes are, most often, self-propelled, for example, by paddles. Some light-weight watercraft may be motorized, see for example U.S. Pat. No. 9,290,251 incorporated herein by reference. Additionally, such watercraft may become overburdened and need flotation equipment to offset the burden, see for example U.S.2016/0159445, incorporated herein by reference.

When the watercraft is motorized, a battery may be needed for the motor, e.g., the battery may store the energy used by the motor. The battery may be housed (or stored or contained or carried) in a case. There is a need for a battery case that may be used with the foregoing watercraft.

### SUMMARY OF THE INVENTION

A method for housing a battery used on a light-weight, motor powered watercraft includes the step of: providing a battery case having: a pod sized to house a marine battery, the pod having a cavity for the marine battery and an open top; a lid for at least water-resistant closure of the open top of the pod, the lid having a cavity and an open bottom, the lid is releasably attachable to the pod; and a floor releasably attached to the lid adjacent the open bottom, the floor adapted to hold controls for the light-weight, motor powered watercraft.

### DESCRIPTION OF THE DRAWING

For the purpose of illustrating the invention, there is shown in the drawings a form that is presently preferred; it being understood, however, that this invention is not limited to the precise arrangements and instrumentalities shown.

FIG. 1 is an environmental view of an embodiment of an inventive battery case mounted on a light-weight, motor powered watercraft (e.g., kayak).

FIG. 2 is an exploded view of the inventive battery case (shown in FIG. 1).

FIG. 3 is a view (from the bow with the seat removed) of the inventive battery case (shown in FIG. 1).

FIG. 4 is a view (from the aft) of the inventive battery case (shown in FIG. 1).

FIG. 5 is a view (from the aft) of the inventive battery case (shown in FIG. 1) opened (or partially disassembled).

### DETAILED DESCRIPTION OF THE INVENTION

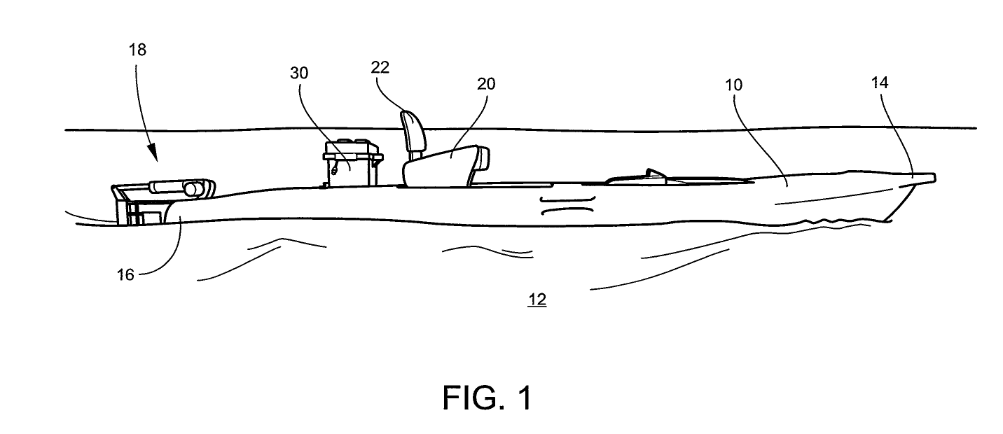

Referring to the drawing, wherein like numerals indicate like elements, there is shown in FIG. 1, an inventive battery case mounted to a light-weight, motor powered watercraft. The battery case is used to house (or store or contain or carry) a battery and electronic circuitry used to power and control the motor system of the watercraft. The case may protect the battery and circuitry from water damage. The case may provide a simple and quick way to remove the battery and circuitry from the watercraft when the watercraft is not in use.

In general and referring to FIG. 1, watercraft 10 floats on water 12. Watercraft 10 may be, for example, a kayak or canoe. The watercraft 10 has a bow 14 and aft (or stern) 16.

A motor system 18 may be located adjacent the stern 16. The motor system may be any motor system. The motor system may include a propulsion system, a guidance system (e.g., maneuvering controls), and/or a actuator system (for raising/lowering the motor into and out of the water while attached to the watercraft). The motor system may be an electrically powered system. One such motor system is disclosed in U.S. Pat. No. 9,290,251, incorporated herein by reference.

A seat 20, with a backrest 22, is positioned on the watercraft 10. The seat 20 may be located anywhere on the watercraft 10. The seat 20 may be located between the bow 14 and stern 16. The seat 20 may be generally located amid ship of the watercraft 10.

A battery case 30 may be positioned anywhere on the watercraft 10. Placement of the battery case 30 may be dependent upon the balance of the watercraft 10 in water 12. In one embodiment, the battery case 30 may be located aft of (or aft and adjacent to) the seat 20. The case 30 may be positioned, so that the operator may have access to the battery and electronics housed in the case while the watercraft is afloat. The battery case 30 is releasably secured to the watercraft 10, as will be discussed in greater detail below. The battery case 30 is discussed in greater detail below.

Optionally, a flotation device (not shown) may be used to facilitate balancing the watercraft 10. One such flotation device is disclosed in U.S.2016/0159445, incorporated herein by reference.

The battery 24 may be any battery. The battery 24 may be a marine battery. The battery 24 may be a rechargeable (or secondary) battery. The rechargeable battery may include: a lead-acid battery or a lithium battery or a nickel-cadmium (Ni—Cd) battery or a fuel cell.

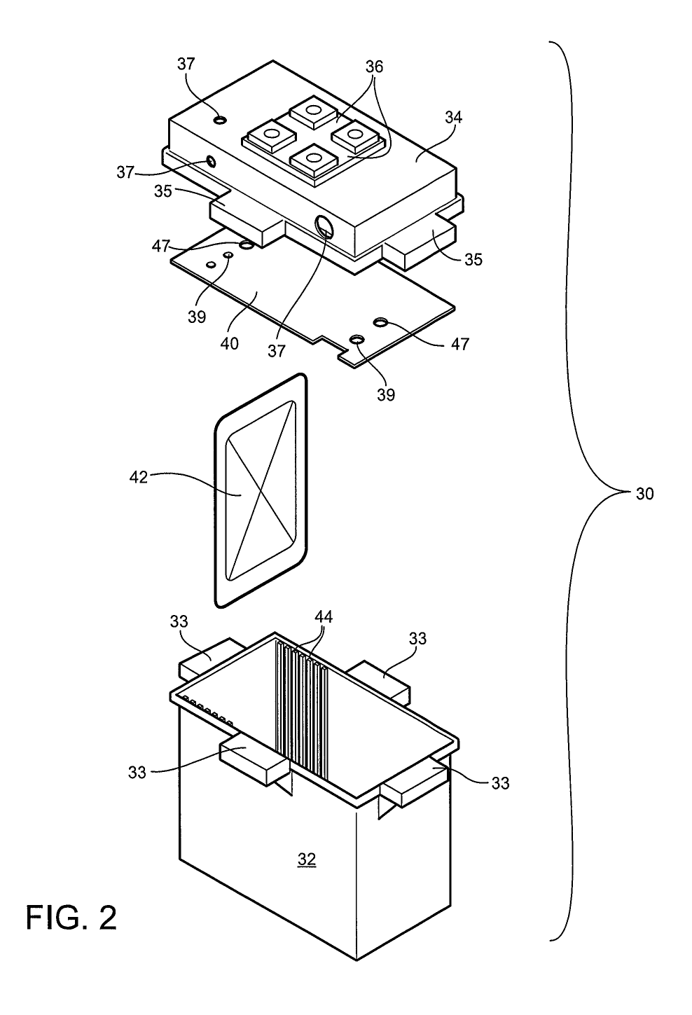

An embodiment of battery case 30 is shown in FIGS. 2-5. Referring to FIG. 2, the battery case 30 generally includes a pod 32, a lid 34, and a floor 40 releasably affixed to the lid. The battery case 30 may optionally include a partition 42. The lid 34, when secured to pod 32, forms a water-resistant (e.g., not water-tight but capable of preventing significant amounts of water from entering the case (for example, preventing egress of splash or spray)) or water-tight seal (e.g., a gasket or an o-ring may be used to facilitate the water-tight seal). The case is not intended to operate while submerged.

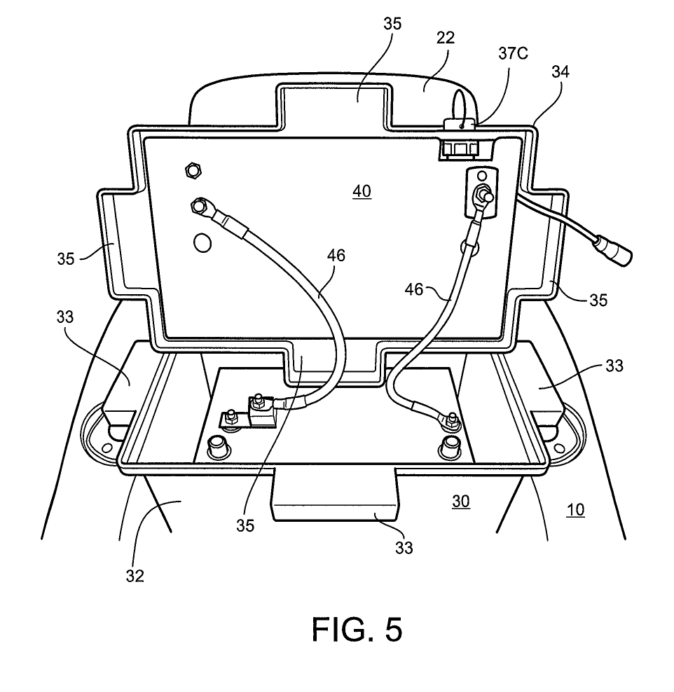

Pod 32 is generally a five sided container with an open top (an upper edge defines the perimeter of the open top) and defining a cavity. Four walls (or sides) define the verticals side of the pod with a fifth side forming the bottom of the pod. Pod 32 is generally sized to house the battery. The pod may be sized so that the battery posts are below the upper edge of the pod (note FIG. 5). Additionally, the pod 32 may be sized so that the battery and any cables fit in the space between the battery posts and the open top (i.e., fit below the lid/floor discussed below). Pod 32 may include a plurality of handles 33. In one embodiment, pod 32 has at least one pair of handles 33. In another embodiment, the pod 32 may have at least two pairs of handles 33. The handles may be used to place the case 30 in the watercraft 10 or remove the case 30 from the watercraft 10. Optionally, pod 32 may include a partition 42. Partition 42 is generally a plate used to increase or decrease the internal size of the pod (i.e., the cavity of the pod) to accommodate batteries of varying size. A plurality of grooves 44, located on the internal surface of the pod 32 may be used to hold the partition in place. The pod 32 may be sized to fit within the tank-well of a kayak.

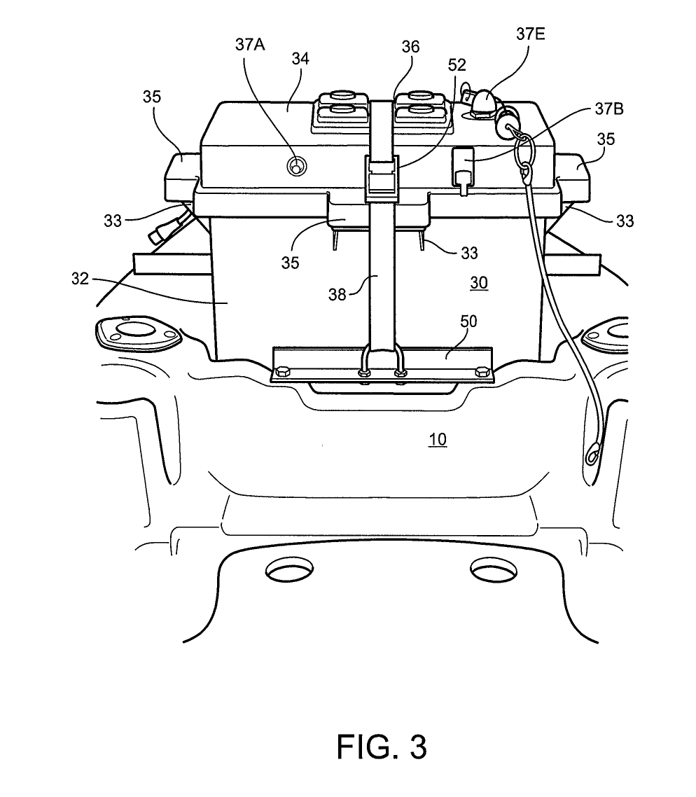

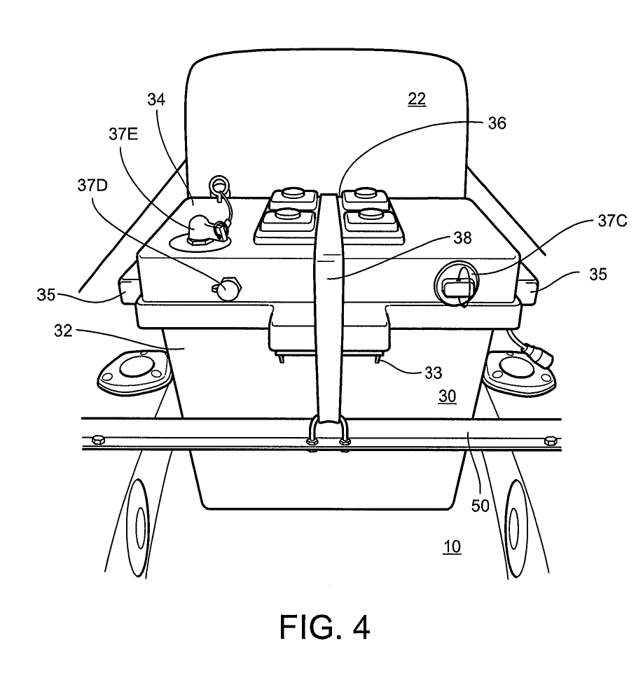

Lid 34 is releasably affixed to (or removable from) pod 32. Lid 34 covers (and seals) the open top of the pod 32, so that water is prevented from contacting the battery 24. Lid 34 is generally a five sided container with an open bottom and a lower edge defining the open bottom. Four walls (or sides) define the verticals side of the lid with a fifth side forming the top of the lid and defining a cavity. The lower edge of the lid may be formed with a ledge (which rests on the upper edge of the pod), and a lip that depends from the ledge and overlaps the upper edge of the pod. A channel 36 is located on a exterior surface of the lid 34. The channel 36 may be used to place a securing strap 38 (see FIGS. 3 and 4) for securing the case to the watercraft. The channel may be located on an upper exterior surface of the lid 34. Lid 34 has a least one channel 36 and may include two or more channels. Lid 34 may also include handles 35. Handles 35 mate with handles 33 of the pod. Lid 34 may include a plurality of holes. These holes allow passage of items from outside to the inside of the case 30. For example, one hole 37A may be for a switch (e.g., actuator switch) to raise/lower the motor system 18, another hole 37B may be for a charge indicator light and/or a battery charging port; another hole 37C may be for a connector (e.g., power and control) to the motor system 18, another hole 37D may be for a connector to the actuator (used to raise/lower the motor system), another hole 37E may be for a kill switch, and one hole may be a vent (preferably water-tight). All connectors attached to the case may be quick connect/release-type connectors and safe for use in wet environments.

Floor 40 is releasably secured (or fastened) to the open bottom of the lid. Floor 40 may rest on the ledge formed adjacent the bottom edge of the lid. Floor 40 may be used secure the electronic circuitry (not shown) used to control the motor system 18 (and/or other electronic devices, for example, fish finder, navigation system, communications system, etc. The electronic circuitry rests on an upper surface of the floor 40 (e.g., in the cavity defined between the top of the lid and the floor). The electronic circuitry is operatively associated with the motor system and the watercraft operator via the holes 37 described above. Floor 40 may include holes 39 for connecting the battery to the circuitry via cables 46 (see FIG. 5). Floor 40 may also include vent holes 47.

In operation, the battery is placed in the pod and the cables are connected between the battery and the electronics. The lid (with the floor fastened thereto) is placed on the pod (the pod is in contact with both the lid and floor at the ledge). Case 30 may be set on the watercraft 10 using handles 33/35. Case 30 may then be secured to the watercraft 10 via one or more straps 38 that are anchored to watercraft 10 via, for example, braces 50. The straps 38 may cross the case 30 front-to-back and/or side-to-side. Straps 38 may include a buckle 52. Buckle 52 may be a quick release buckle. The connections between the case and the operator controls and the motor system, may be made before or after securing the pod to the watercraft. After use, the case may be removed from watercraft 10 by reversing the setting steps.

The present invention may be embodied in other forms without departing from the spirit and the essential attributes thereof, and, accordingly, reference should be made to the appended claims, rather than to the foregoing specification, as indicated the scope of the invention.

I claim:

1. A method for housing a battery used on a light-weight, motor powered watercraft comprises the step of:
providing a battery case having:
a pod sized to house a marine battery, the pod having a cavity for the marine battery and an open top;
a lid for at least water-resistant closure of the open top of the pod, the lid having a cavity and an open bottom, the lid is releasably attachable to the pod; and
a floor releasably attached to the lid adjacent the open bottom, the floor adapted to hold controls for the light-weight, motor powered watercraft.

2. The method of claim 1 wherein the watercraft is a kayak.

3. The method of claim 1 wherein the battery case includes one or more holes through a wall of the battery case.

4. The method of claim 1 wherein the lid further comprises at least one channel for receipt of an anchoring strap.

5. The method of claim 1 wherein the pod includes a partition.

6. The method of claim 1 wherein the battery sits below an upper edge of the pod.

7. The method of claim 1 wherein the controls include electronic circuitry.

8. The method of claim 7 wherein the circuitry is located with the cavity of the lid.

9. A battery case for a light-weight, motor powered watercraft comprising:
a pod sized to house a marine battery, the pod having a cavity for the marine battery and an open top;
a lid for at least water-resistant closure of the open top of the pod, the lid having a cavity and an open bottom, the lid is releasably attachable to the pod; and
a floor releasably attached to the lid adjacent the open bottom, the floor adapted to hold controls for the light-weight, motor powered watercraft.

10. The case of claim 9 wherein the watercraft is a kayak.

11. The case of claim 9 wherein the battery case includes one or more holes through a wall of the battery case.

12. The case of claim 9 wherein the lid further comprises at least one channel for receipt of an anchoring strap.

13. The case of claim 9 wherein the pod includes a partition.

14. The case of claim 9 wherein the battery sits below an upper edge of the pod.

15. The case of claim 9 wherein the controls include electronic circuitry.

16. The case of claim 15 wherein the circuitry is located with the cavity of the lid.
